(19) United States
(12) Patent Application Publication
(10) Pub. No.: US 2006/0176799 A1
(43) Pub. Date: Aug. 10, 2006

(54) Optical information recording method and optical information recording and reproducing apparatus utilizing holography

(76) Inventor: Masatoshi Hirono, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/229,730

(22) Filed: Sep. 20, 2005

(30) Foreign Application Priority Data
Feb. 10, 2005 (JP) 2005-034583

(51) Int. Cl. G11B 7/00

(52) U.S. Cl. 369/103; 369/112.01; 369/275.1

(57) ABSTRACT

Onto a recording medium including a hologram recording layer, there is condensed information light generated based on information to be recorded and including zero-order diffracted light and high-order diffracted light of a first or more order to thereby record onto the hologram recording layer the information as interference fringes generated by interference of the zero-order diffracted light with the high-order diffracted light.

### CROSS-REFERENCE TO RELATED APPLICATIONS

This application is based upon and claims the benefit of priority from prior Japanese Patent Application No. 2005-034583, filed Feb. 10, 2005, the entire contents of which are incorporated herein by reference.

### BACKGROUND OF THE INVENTION

1. Field of the Invention

The present invention relates to a method of recording optical information in a recording medium by using holography, and to an information-recording and reproducing apparatus by using holography.

2. Description of the Related Art

A method is known, which records optical information by using holography. The method utilizes a recording medium that has a hologram recording layer. The information is recorded in the recording medium, in the form of interference fringes generated as the information light interferes with reference light whose phase and intensity have been spatially modulated. The information thus recorded is reproduced by applying to the recording medium the same reference light as used to record the optical information.

H. Horimai and J. Li, Optical Data Storage Topical Meeting 2004 Technical Digest, TuDS (2004) P258, and Jpn. Pat. Appln. KOKAI Publication No. 2004-134048, describe apparatuses that record and reproduce the information by using holography. These apparatuses has a spatial light modulator, which performs intensity modulation on the beam emitted from a laser and then collimated by a lens, in accordance with the information to be recorded. The intensity distribution in the cross section of the laser beam thus carries the information. In the cross section of the light beam thus modulated in intensity, the information light carrying the information internally occupies the center part, whereas the reference light carrying a cryptography key occupies the part surrounding the center part.

The intensity-modulated laser beam passes through a beam splitter. The laser beam emerging from the beam splitter is applied to an objective lens. The objective lens focuses the laser beam on a recording medium. The recording medium has a hologram recording layer and a reflective layer. The information is recorded in the form of interference fringes generated as the information light and the reference light interferes in the hologram recording layer.

The recording medium in which the information has been recorded may be irradiated with the reference light that has been intensity-modulated in the same way as the information light applied to the medium to record the information. In this case, the recording medium generates light from the interference fringes by virtue of the principle of holography. This light, which carries the information recorded in the medium, is guided through the objective lens to the beam splitter. The beam splitter reflects the light, which reaches an image-detecting device such as an imaging device. The imaging device generates an image signal corresponding to the information reproduced from the recording medium.

In the conventional optical recording method by using holography, a part of the modulated light needs must be treated as information light, and the remaining part as reference light. Therefore, the spatial light modulator must be a large one to secure a sufficiently large region for the information light. This inevitably makes it difficult to miniaturize the recording apparatus. On the other hand, if the spatial light modulator is a small one, the region for the information light is proportionally small in the cross section of the light that has been intensity-modulated. This reduces the amount of information per page, i.e., the efficiency of recording information in the recording radium.

### BRIEF SUMMARY OF THE INVENTION

An object of the present invention is to provide an optical information recording method and an optical information recording and reproducing apparatus in which a light utilization efficiency is improved to facilitate miniaturization of the apparatus or increase in a recording capacity.

According to an aspect of the present invention, an optical information recording method using a recording medium including a hologram recording layer is provided. The method comprises generating information light from a laser beam based on information to be recorded, the information light including zero-order diffracted light and high-order diffracted light of a first or more order; and recording the information as interference fringes generated by interference of the zero-order diffracted light with the high-order diffracted light in the recording medium by means of the information light.

According to another aspect of the present invention, an optical information recording apparatus using a recording medium including a hologram recording layer is provided. The apparatus comprises a light source which generates a laser beam; a generation unit configured to generate information light from the laser beam based on information to be recorded, the information light including zero-order diffracted light and high-order diffracted light of a first or more order; and a recording unit configured to record the information as interference fringes generated by interference of the zero-order diffracted light with the high-order diffracted light in the recording medium by means of the information light.

According to another aspect of the present invention, an optical information recording and reproducing apparatus using a recording medium including a hologram recording layer is provided. The apparatus comprises a light source generating laser beam; a spatial light modulator which assumes a modulation state at a recording time to thereby subject the laser beam to intensity modulation based on information to be recorded and generate information light including zero-order diffracted light and high-order diffracted light of a first or more order in the modulation state and which assumes a non-modulation state at a reproducing time to thereby transmit the laser beam and generate reference light; an objective lens configured to condense the information light onto the recording medium in order to record the information as interference fringes generated by interference of the zero-order diffracted light with the high-order diffracted light of the first or more order in the recording medium at the recording time and to condense the reference light onto the recording medium at the reproducing time; and a reproducing unit which detects reflected light from the recording medium based on the reference light to thereby reproduce the information recorded in the recording medium at the reproducing time.

### BRIEF DESCRIPTION OF THE SEVERAL VIEWS OF THE DRAWING

FIG. 1 is a schematic diagram of an optical-information recording apparatus according to an embodiment of the invention;

FIG. 2 is a diagram representing the intensity distribution in a cross section of information light shown in FIG. 1;

FIG. 3 is a schematic diagram of an optical-information reproducing apparatus according to another embodiment of the invention; and

FIG. 4 is a diagram representing the intensity distribution in a cross section of information light shown in FIG. 2.

### DETAILED DESCRIPTION OF THE INVENTION

An embodiment of the present invention will be described, with reference to the accompanying drawings.

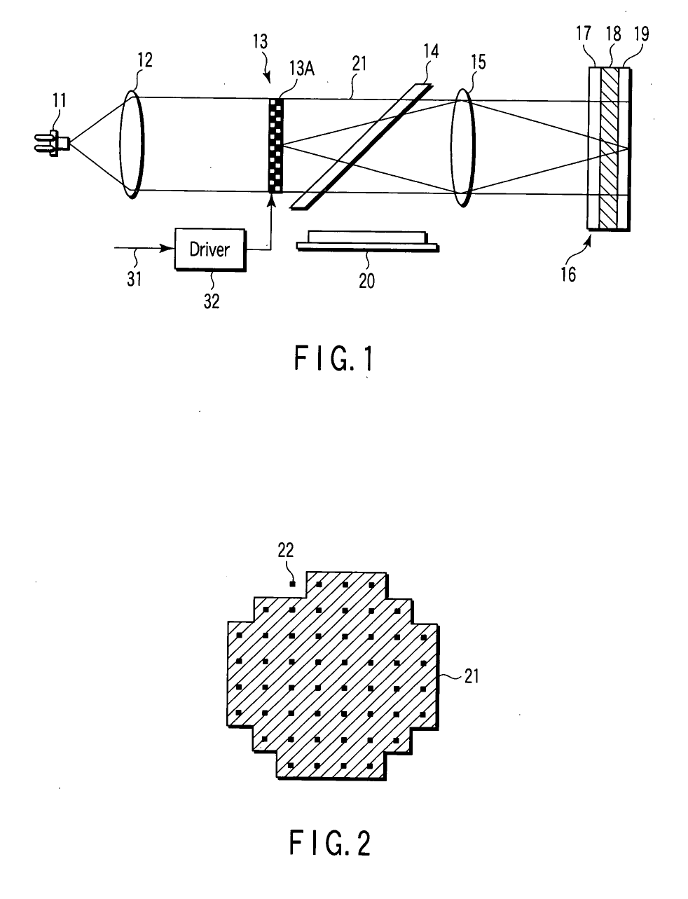

An optical information recording apparatus according to an embodiment of the invention and how the apparatus operates will be described with reference to FIG. 1.

The apparatus has a laser light source 11, a collimation lens 12, a spatial light modulator 13, a beam splitter 14, an objective lens 15, an image-detecting device 20, and a driver 32. The laser light source 11 emits a laser beam. The collimation lens 12 converts the laser beam to a parallel pencil. The parallel pencil is applied to the spatial light modulator 13. The spatial light modulator 13 is, for example, a liquid crystal device or a digital micro mirror device (DMD). It includes a pixel array 13A that has a plurality of pixels arranged in a matrix form. The driver 32 receives the Information (e.g., image information) 31 to be recorded in a recording medium 16. The driver 32 is connected to the spatial light modulator 13. When the spatial light modulator 13 is the liquid crystal device, the driver 32 drives the spatial light modulator 13, setting each pixel of the pixel array 13A, selectively in a transmitted state or an interrupted state, in accordance with the information 31. When the spatial light modulator 13 is the DMD, the driver 32 drives the spatial light modulator 13, setting each pixel of the pixel array 13A, selectively in a state to reflect an incident light outside or a state to reflect the incident light inside, in accordance with the information 31. The spatial light modulator 13 modulates the intensity of the light incident to it, at high spatial frequency, in accordance with the information 31. Thus, the spatial light modulator 13 generates information light 21.

The cross section of the light beam thus modulated in intensity has such an intensity distribution as shown in FIG. 2, representing the information to be recorded in the recording medium 16. Namely, the information light 21 has a sectional pattern (modulation pattern). The modulation pattern includes positioning markers 22 required that are used to reproduce the information. Nonetheless, the information light may have any other modulation pattern than this.

As indicated above, the spatial light modulator 13 modulates the intensity of the incident light at high spatial frequency. The light information light 21 includes zero-order diffracted light and first-order or higher-order diffracted light. (The first-order or higher order diffracted light will be referred to as high-order diffracted light, to be distinguished from the zero-order diffracted light.) The information light 21 passes through a beam splitter 14, reaching the objective lens 15. The objective lens 15 condenses the light 21 on the recording medium 16.

The recording medium 16 comprises a transparent substrate 17, a hologram recording layer 18, and a reflective layer 19. The layers 18 and 19 are laminated on the substrate 17, one upon the other. When the objective lens 15 condenses the information light 21 on the recording medium 16, the zero-order diffracted light and the high-order diffracted light interfere with each other, generating interference fringes obtained in the hologram recording layer 18. The information 31 is recorded, in the form of interference fringes in the hologram recording layer 18.

The principle of information recording, according to this embodiment, will be explained. If the information light 21 represents a great amount of information, its intensity distribution is modulated at high spatial frequency, and is thereby diffracted. As Abbe's image formation theory teaches, the high-order diffracted light (i.e., AC components) included in the information light 21 represents the information. By contrast, the zero-order diffracted light (i.e., DC components) included in the information light 21 represents no information, because its diffraction angle is zero. This does not mean that the zero-order diffracted light contribute nothing to image formation at the spatial light modulator 13. It has certain amplitude and can interfere with the high-order diffracted light, to correct the image formed by the spatial light modulator 13. The present embodiment utilizes this principle, recording and reproducing information in and from the recording medium 16.

This embodiment use no reference light unlike a conventional technology described in H. Horimai and J. Li, Optical Data Storage Topical Meeting 2004 Technical Digest, TuD5 (2004) P258, and Jpn. Pat. Appln. KOKAI Publication No. 2004-134048. Hence, the information light 21 condensed onto the recording medium 16 is subjected to the intensity modulation by the spatial light modulator 13 to carry the information in the information light 21, the information light 21 is diffracted in response to the modulation. When the information light 21 obtained in this manner is condensed onto the recording medium 16 by the objective lens 15, the interference fringes are formed on the recording medium 16 by the interference of the zero-order diffracted light whose travel direction does not change even when the light is diffracted with the high-order diffracted light whose travel direction has changed by the diffraction.

In this embodiment, the information is recorded in the form of interference fringes, by using the information light 21 only. No reference light is used to record the information in the recording medium 16, unlike in the conventional technique. Hence, the spatial light modulator 13 can be smaller than in the conventional technique, to make the information light 21 carry the same amount of information. If the spatial light modulator 13 is as large as the one used in the conventional technique, the information light 21 can carry more information than in the conventional technique. Thus, the recording capacity per page increases.

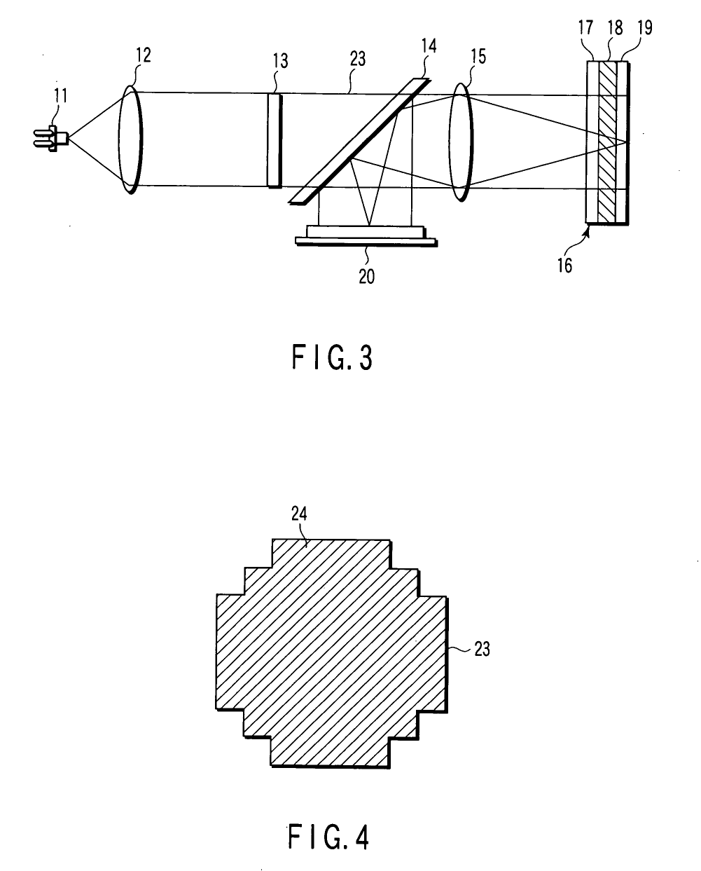

Next, an optical information reproducing apparatus according to another embodiment of the invention and how this apparatus operates will be described with reference to FIG. 3. The optical information reproducing apparatus is suitable for reproducing information from the recording medium 16 in which the information has been recorded by the optical information recording apparatus of FIG. 1. Nevertheless, the optical information reproducing apparatus can effectively reproduce information from a recording medium in which the information has been recorded by an optical information recording apparatus other than that of FIG. 1.

FIG. 3 shows, the optical information reproducing apparatus has a laser light source 11, a collimation lens 12, a spatial light modulator 13, a beam splitter 14, an objective lens 15, an image-detecting device 20, and a driver 32. The laser light source 11 emits a laser beam. The collimation lens 12 converts the laser beam to a parallel pencil. The parallel pencil is applied to the spatial light modulator 13. The spatial light modulator 13 does not perform intensity modulation as in the case of recording information in the recording medium 16. That is, as shown in FIG. 4, the spatial light modulator 13 emits reference light 23 having a sectional intensity distribution similar to that of the zero-order diffracted light included in the information light 21 applied to the medium 16 to record the information therein.

The reference light 23 passes through the beam splitter 14, reaching the objective lens 15. The objective lens 15 condenses the reference light on the recording medium 16. When the reference light 23, or zero-order diffracted light, is applied to the recording medium 16, the high-order diffracted light included in the information light 21 applied to the medium, recording the information, is restored. The reflective layer 19 reflects this high-order diffracted light, by virtue of holography. The high-order diffracted light, thus reflected, includes the zero-order diffracted light, i.e., a component of the emitted reference light 23. This is because the efficiency of restoring the high-order diffracted light cannot reach 100%.

The light reflected from the reflective layer 19 travels through the objective lens 15 in the direction reverse to that of the information light applied to record the information. The beam splitter 14 reflects the light, which is applied to the image-detecting device 20 that is so positioned to have an optically conjugated relation with the spatial light modulator 13. The light forms an image that has the same sectional intensity distribution as the image formed of the information light 21 applied to the medium 16 to record the information. As the image detection device 20, a solid imaging device is usable such as a CCD imaging device or a CMOS imaging device. The image-detecting device 20 generates a signal representing the information (e.g., image information) recorded in the form of interference fringes in the recording medium 16.

As shown in FIG. 4, a pattern of the reference light 23 includes a marker 24 for positioning the information light 21 of FIG. 2. The patterning is performed in order to improve a contrast of the reproduction signal. The pattern may be replaced by any other patterns.

As described above, in one embodiment of the invention, information is recorded, utilizing holography, by applying information light generated based on the information and including zero-order diffracted light and high-order diffracted light of the first or higher order. Since no reference light is required to record the information, the efficiency using light increases. This makes it possible to miniaturize the data-recording apparatus or increases in the efficiency of recording information.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An optical information recording method using a recording medium including a hologram recording layer, comprising:
generating information light from a laser beam based on information to be recorded, the information light including zero-order diffracted light and high-order diffracted light of a first or more order; and
recording the information as interference fringes generated by interference of the zero-order diffracted light with the high-order diffracted light in the recording medium by means of the information light.

2. The method according to claim 1, wherein the generating of the information light comprises subjecting the laser beam to intensity modulation based on the information to thereby generate the information light.

3. The method according to claim 1, wherein the generating of the information light comprises converting the laser beam into a parallel pencil; allowing the parallel pencil to enter a pixel array having a plurality of pixels arranged in a matrix form; and selectively setting each of the pixels into either of a transmitted state or an interrupted state in accordance with the information thereby emit the information light from the pixel array.

4. The method according to claim 1, wherein the generating of the information light comprises converting the laser beam into a parallel pencil; allowing the parallel pencil to enter a pixel array having a plurality of pixels arranged in a matrix form; and selectively setting each of the pixels into either of a state to reflect an incident light outside or a state to reflect the incident light inside in accordance with the information thereby emit the information light from the pixel array.

5. The method according to claim 1, wherein the recording of the information comprises condensing the information light onto the recording medium.

6. An optical information recording apparatus using a recording medium including a hologram recording layer, comprising:
a light source which generates a laser beam;
a generation unit configured to generate information light from the laser beam based on information to be recorded, the information light including zero-order diffracted light and high-order diffracted light of a first or more order; and
a recording unit configured to record the information as interference fringes generated by interference of the zero-order diffracted light with the high-order diffracted light in the recording medium by means of the information light.

7. The optical information recording apparatus according to claim 5, wherein the generation unit comprises a spatial light modulator which subjects the laser beam to intensity modulation based on the information to be recorded to thereby generate the information light.

8. The optical information recording apparatus according to claim 7, wherein the spatial light modulator comprises a pixel array which has a plurality of pixels arranged in a matrix form and wherein each of the pixels is selectively set into either of a transmitted state or an interrupted state in accordance with the information.

9. The optical information recording apparatus according to claim 7, wherein the spatial light modulator comprises a pixel array which has a plurality of pixels arranged in a matrix form and wherein each of the pixels is selectively set into either of a state to reflect an incident light outside or a state to reflect the incident light inside in accordance with the information thereby emit the information light from the pixel array.

10. The optical information recording apparatus according to claim 6, wherein the generation unit comprises a lens which converts the laser beam into a parallel pencil; and a pixel array which is disposed in such a manner that the parallel pencil enters the pixel array and which has a plurality of pixels arranged in a matrix form and in which each pixel is selectively set into either of a transmitted state or an interrupted state in accordance with the information to thereby emit the information light.

11. An optical information recording and reproducing apparatus using a recording medium including a hologram recording layer, comprising:
a light source generating laser beam;
a spatial light modulator which assumes a modulation state at a recording time to thereby subject the laser beam to intensity modulation based on information to be recorded and generate information light including zero-order diffracted light and high-order diffracted light of a first or more order in the modulation state and which assumes a non-modulation state at a reproducing time to thereby transmit the laser beam and generate reference light;
an objective lens configured to condense the information light onto the recording medium in order to record the information as interference fringes generated by interference of the zero-order diffracted light with the high-order diffracted light of the first or more order in the recording medium at the recording time and to condense the reference light onto the recording medium at the reproducing time; and
a reproducing unit which detects reflected light from the recording medium based on the reference light to thereby reproduce the information recorded in the recording medium at the reproducing time.

12. The optical information recording and reproducing apparatus according to claim 10, wherein the spatial light modulator comprises a pixel array which has a plurality of pixels arranged in a matrix form and wherein each of the pixels selectively assumes either of a transmitted state or an interrupted state.

13. The optical information recording and reproducing apparatus according to claim 10, which further comprises a collimation lens configured to convert the laser beam into a parallel pencil, wherein the spatial light modulator comprises a pixel array which has a plurality of pixels arranged in a matrix form and which is disposed in such a manner that the parallel pencil enters the array of pixels and wherein each of the pixels is selectively set into either of a transmitted state or an interrupted state in accordance with the information to thereby emit the information light including the zero-order diffracted light and the high-order diffracted light of the first or more order at the recording time and wherein all of the pixels are set into the transmitted state to thereby generate the reference light at the reproducing time.

14. The optical information recording and reproducing apparatus according to claim 10, which further comprises a collimation lens configured to convert the laser beam into a parallel pencil, wherein the spatial light modulator comprises a pixel array which has a plurality of pixels arranged in a matrix form and which is disposed in such a manner that the parallel pencil enters the array of pixels and wherein each of the pixels is selectively set into either of a state to reflect an incident light outside or a state to reflect the incident light inside in accordance with the information to thereby emit the information light including the zero-order diffracted light and the high-order diffracted light of the first or more order at the recording time and wherein all of the pixels are set into the transmitted state to thereby generate the reference light at the reproducing time.

15. The optical information recording and reproducing apparatus according to claim 10, wherein the reproducing unit comprises an image-detecting device configured to detect an image formed by the reflected light that has passed through the objective lens.
